(19) United States
(12) Patent Application Publication
(10) Pub. No.: US 2017/0048385 A1
(43) Pub. Date: Feb. 16, 2017

(54) TECHNIQUES FOR PROVIDING TELECOMMUNICATION SERVICES TO AN ACCESSORY DEVICE

(71) Applicant: Bandwidth.com, Inc., Raleigh, NC (US)

(72) Inventors: Jared Kashimba, Micanopy, FL (US); Sai Rathnam, Raleigh, NC (US)

(21) Appl. No.: 15/337,361

(22) Filed: Oct. 28, 2016

Related U.S. Application Data
(60) Provisional application No. 62/293,476, filed on Feb. 10, 2016.

(51) Int. Cl. H04M 3/42; H04W 68/00; H04W 76/02; H04B 1/3827; H04W 60/00

(52) U.S. Cl. CPC H04M 3/42263; H04B 1/3827; H04W 60/00; H04W 76/02; H04W 68/005; H04W 4/008

(57) ABSTRACT

The embodiments described herein are generally directed to systems and methods for intelligently structuring, handling, and enhancing communication sessions between or among communication devices including traditional telephony endpoints (e.g., phones) and non-traditional endpoints (e.g., automobiles, accessory devices, wearable accessory devices) among others. Some embodiments are particularly directed to call forwarding policies for providing the ability to make and receive telephone calls intended for a specific telephony endpoint (e.g. mobile phone, VoIP phone, POTS phone) on an accessory device using the telephony endpoint's identity (e.g., telephone number) even when the accessory device and mobile phone (or other telephony endpoint) are separated by great distances or when the mobile phone (or other telephony endpoint) is otherwise unavailable. Various embodiments described herein may enable selective implementation of the call forwarding policies.

### CROSS-REFERENCE TO RELATED APPLICATIONS

The present application claims priority to U.S. Provisional Patent Application No. 62/293,476, filed on Feb. 9, 2016 and titled “Providing Telecommunication Services to an Accessory Device,” the entirety of which is incorporated by reference herein.

### BACKGROUND

Mobile telephony devices utilizing wireless communication protocols are ubiquitous. Many of these devices utilize one of the competing circuit-switched or Internet Protocol (IP) cellular networks (e.g., GSM or CDMA) to place and receive telephone calls to other telephony endpoint devices. Typically, a telephony endpoint device may include another mobile telephony device on the same or another circuit-switched or IP cellular network, a Voice-over-IP (VoIP) telephony device operable over an IP network such as the Internet, and/or a plain old telephone service (POTS) telephony device operable over the public switched telephone network (PSTN). Each of these telephony endpoint devices may use a different access network but may all be interfaced at some point to allow for communication among the different networks.

Recently, there has been introduced another type of mobile device more broadly termed an accessory device. An accessory device may refer to a portable mobile device that may be equipped with one or more RF radios capable of networked communications over one or more distinct networks using one or more distinct protocols. An accessory device may be characterized as a wearable device such as a watch, bracelet, or a fitness dongle. The accessory device may specifically include RF radios capable of communication over 802.11 WiFi, Bluetooth, and/or cellular banded communications using either circuit-switched wireless protocols (e.g., global system for mobile communications (GSM) or code division multiple access (CDMA)) or IP based wireless protocols (e.g., long term evolution (LTE)).

Heretofore, an accessory device has been paired or linked with another device like a mobile phone typically over a Bluetooth wireless link. Bluetooth is a very short range (e.g., 10-20 feet) wireless protocol used to exchange data/signals between two paired devices. Using Bluetooth, for instance, a mobile phone and an accessory device like a smartwatch may pair when in range of one another and the smartwatch may be able to perform many of the functions native to the mobile phone such as making and receiving telephone calls. This is possible because the mobile phone is still performing the core functions and the smartwatch has access to the “data” (e.g., voice data and call signaling) via the Bluetooth link. If the mobile phone and smartwatch are separated by too much distance, the wireless connection is lost and all communication between the two devices is terminated.

Thus, Bluetooth limits the capabilities of the accessory device to a relatively minimal distance with respect to a mobile phone or other Bluetooth enabled telephony endpoint. If a user were to go for a jog and leave her mobile phone behind, she would lose the ability to receive telephone calls on her accessory device (e.g., smartwatch) while out of Bluetooth range of the mobile phone.

### BRIEF DESCRIPTION OF THE DRAWINGS

FIG. 1 illustrates a prior art exemplary networked environment for communication between an accessory device and another communication device endpoint.

FIG. 2 illustrates an exemplary networked environment for communication between an accessory device and another communication device endpoint.

FIG. 3A illustrates an embodiment of a logic flow for establishing a communication session between an accessory device and another communication device endpoint.

FIG. 3B illustrates an embodiment of a logic flow for establishing a communication session between an accessory device and two other communication device endpoints.

FIG. 4A illustrates another exemplary networked environment for communication between an accessory device and another communication device endpoint.

FIG. 4B illustrates yet another exemplary networked environment for communication between an accessory device and another communication device endpoint.

FIG. 4C illustrates still another exemplary networked environment for communication between an accessory device and another communication device endpoint.

FIG. 5 illustrates yet another embodiment of a logic flow for establishing a communication session between an accessory device and another communication device endpoint.

FIG. 6 illustrates an embodiment of an exemplary computing architecture 600 suitable for implementing various embodiments as previously described.

### DETAILED DESCRIPTION

The embodiments described herein are generally directed to systems and methods for intelligently structuring, handling, and enhancing communication sessions between or among communication devices including traditional telephony endpoints (e.g., phones) and non-traditional endpoints (e.g., automobiles, accessory devices, wearable accessory devices) among others. Some embodiments are particularly directed to call forwarding policies for providing the ability to receive telephone calls intended for a specific telephony endpoint (e.g. mobile phone, VoIP phone, POTS phone) on an accessory device using the telephony endpoint's identity (e.g., telephone number) even when the accessory device and mobile phone (or other telephony endpoint) are separated by great distances. Various embodiments described herein may enable selective implementation of the call forwarding policies. In some embodiments, the call forwarding policies may forward the call to an IP address comprising a socket address combination of an internet protocol (IP) address and a port number associated with an accessory device. The systems and methods described herein may be embodied in and performed by communication devices, call servers and other devices, and software instructions executed by some or all of such devices, as will be explained in detail below. The different types of networks contemplated herein include, for example, cellular mobile networks, the public switched telephone network (PSTN), and data networks, such as the Internet or other IP-based networks, including wide area networks, local area networks, cellular data networks, and combinations thereof.

As used herein, the term “communication session” may refer to any one-way or two-way exchange of information between two or more communication devices. Communication sessions may include voice, data, video, and multimedia communication sessions, or any other type of data communication sessions or messaging exchanges. As used herein, the term “communication device” may refer to traditional telephony endpoints (e.g., phones) and non-traditional endpoints such as accessory devices. As used herein, the term “accessory device” may refer to any non-traditional telephony endpoint equipped with a radio that can utilize one or more networks or protocols associated with voice telecommunications. Thus, an accessory device may include an automobile, a boat, a bike, a smartwatch, a fitness tracking dongle, other jewelry, smartglasses, and more. As used herein, the term “communication link” may refer to a physical or logical channel that connects two or more communication devices. In some embodiments, a communication link may be a signaling link or a media link. In various embodiments, a communication session may be established via one or more communication links. In various such embodiments, one or more media streams may be transmitted over the one or more communication links. In some embodiments, a call server may be situated between communication devices thereby making the call server an endpoint in a communication link of one or more communication links that establish a communication session. In some such embodiments, the call server may be hosted within an IP network such as, for instance, the Internet or a LAN/WAN accessible to the Internet.

The convergence of and inter-operation among different types of network technologies (e.g., heterogeneous network inter-operability) may blur the line between various distinct networks. As described herein, access networks may be characterized as the portion of a communications network that connects subscriber communication devices to a service provider's core network. Also, as described herein, an access network may be referred to as the interface between the communication device and the network. Another type of interface referenced herein may be the interface between networks, that is, the interface necessary to facilitate seamless communications from one network to another.

Therefore, references herein to a communication device capable of connecting to or communicating via a mobile carrier network may refer to a communication device equipped with a cellular transceiver for wireless communication with basestations and other mobile carrier network access points. Similarly, references herein to a communication device capable of connecting to or communicating via a data network may refer to a communication device equipped with a transceiver or other network interface for wireless communication (e.g., 802.11) with a router or other data network access point. One particular communication device may be characterized herein as a wireless handset. A wireless handset may include multiple RF transceivers, one of which may be operable to connect to an access network for a mobile carrier network (e.g., cellular network) using either or both of a circuit-switched protocol or an IP protocol and another of which may be operable to connect to an access network for an IP data network (e.g., 802.11) such as the Internet.

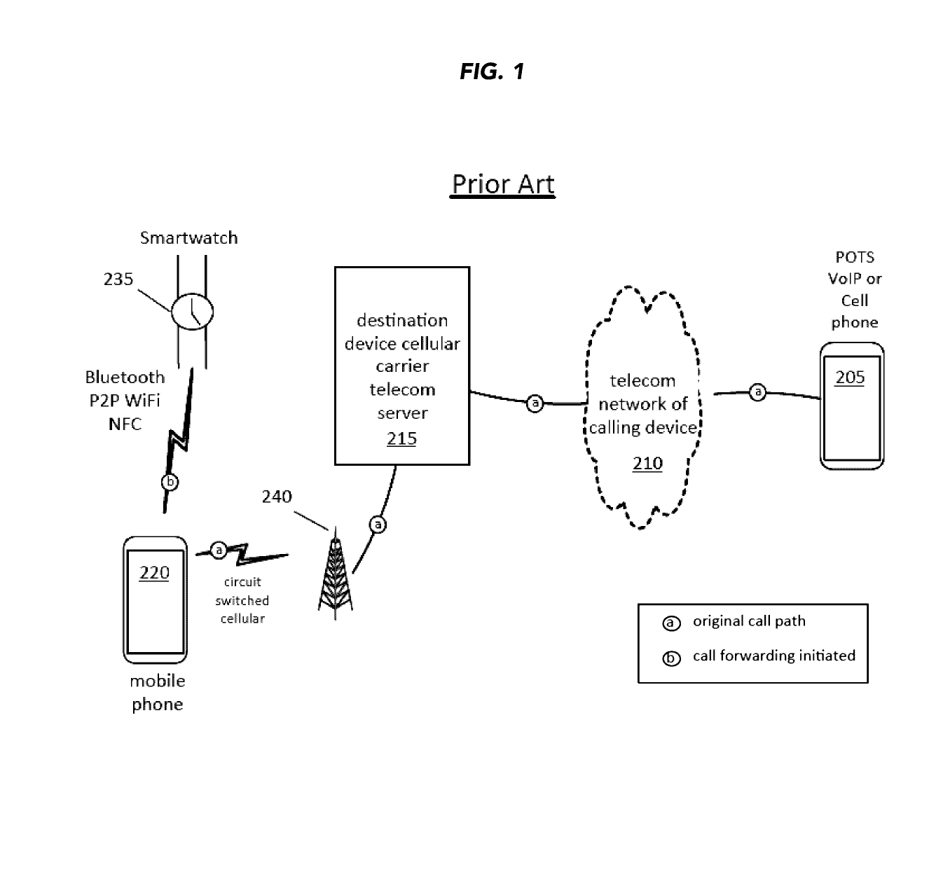

FIG. 1 illustrates a prior art exemplary networked environment for communication between an accessory device 235 and a communication device endpoint. In the illustrated embodiment, the communication device endpoint may include first telephony endpoint 205. In various embodiments, the first telephony endpoint 205 which may be a POTS, VoIP, or mobile phone places a call to mobile telephony endpoint 220. The first telephony endpoint 205 may communicate via a telecom network 210 associated with the first telephony endpoint 205. The telecom network 210 associated with the first telephony endpoint 205 may connect with a mobile carrier telecom server 215 associated with the mobile telephony endpoint 220. The mobile carrier telecom server 215 may communicate with the mobile telephony endpoint 220 by way of a radio basestation 240 to establish a communication session between the first telephony endpoint 205 and the mobile telephony endpoint 220.

The mobile telephony endpoint 220 may be further connected to an accessory device 235 such as, for instance, a smartwatch using a short range wireless communication link. The short range wireless communication link may include Bluetooth, peer-to-peer (P2P) WiFi, or another near field communication (NFC) protocol. The short range wireless communication link permits the accessory device 235 and the mobile telephony endpoint 220 to exchange data including voice and/or signaling data among other types of data. The short range wireless communication link may be configured to allow a communication session to be extended to the accessory device 235. So long as the short range wireless communication link remains intact, the accessory device 235 may stay involved in the communication session using the mobile telephony endpoint 220 as the connection to the larger telecommunications network and when the short range wireless communication link is broken, the accessory device 235 may no longer be involved in the communication session. Thus, the accessory device's 235 involvement in the communication session is limited by the short range wireless communication link. This may present a significant problem if a user possesses the accessory device 235 but is significantly out of range of the short range wireless communication link of the mobile telephony endpoint 220.

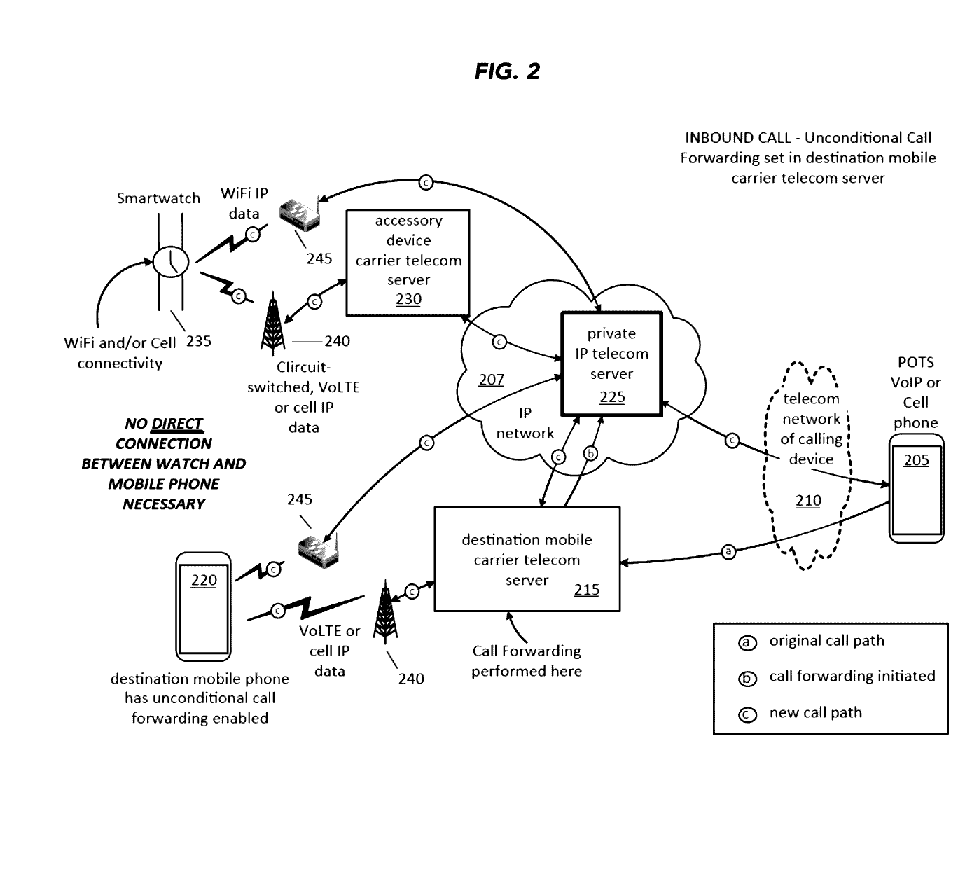

The networked environments shown in FIGS. 2, 4A, 4B, and 40 may include multiple distinct inter-connected networks such as, for instance, a large scale internet protocol (IP) network (e.g., the Internet) and any associated access points, telecom network servers, including the telecom network servers associated with a calling and a called telephony endpoint device. The telecom networks of the telephony endpoint devices may include any combination of the PSTN, an IP network, or a mobile carrier network depending the type of the telephony endpoint device. While these distinct networks utilize different protocols and signaling schemes, there are various interfaces that allow for the seamless transition of signaling, voice, and data (including text, audio, and video) such that various communication endpoints may communicate with one another over one or more of these inter-connected networks. Embodiments are not limited in this context.

The PSTN may be characterized as a circuit switched point-to-point communications network in which a physical connection between the endpoints is maintained for the duration of the connection. The PSTN may also be referred to as the legacy telephone network as it is the backbone infrastructure for connecting endpoints comprised of POTS phones.

Mobile carrier networks (sometimes referred to as cellular networks) may come in different varieties based on the radio transmission scheme between a communication device known as a wireless handset (e.g., mobile telephone endpoint 220) and the mobile carrier network basestation that is in communication with the wireless handset. Two such circuit-switched radio transmission schemes are the GSM and CDMA. These radio transmission schemes are incompatible with one another necessitating an intervening interface to allow communication between endpoints on either network. In addition, each network may operate over specific frequency ranges. Often, there may even be an intervening network such as the PSTN between two distinct mobile carrier networks. Each mobile carrier network may include an interface to the PSTN such that calls crossing that interface can be handled by the receiving network whether it is a mobile carrier network or the PSTN.

Mobile carrier networks also may utilize cellular radio based IP data transmission protocols such as, for instance, LTE. There are numerous cellular radio based IP data transmission protocols in existence that are different from one another with one key similarity—the ability to send and receive IP data packets. Thus, this disclosure may simply use the term cellular IP data to refer to all of them. Cellular IP data is, however, separate and distinct from circuit-switched cellular.

Various mobile carrier network operators may base their network on one of the radio transmission schemes and provide service to wireless handsets (e.g., mobile telephony endpoint 220) using that radio transmission scheme over a defined frequency band. For example, a wireless handset may wirelessly communicate with a basestation that serves as an access point to the mobile carrier network. The basestation may authenticate and authorize the wireless handset to the mobile carrier network and, in conjunction with other equipment within the mobile carrier network, manage calls to and from the wireless handset and may include call forwarding policies such as, for instance, unconditional call forwarding. In some embodiments, the call forwarding policies may be performed based on one or more settings of or actions by the wireless handset. Unconditional call forwarding may refer to a feature that redirects an inbound call intended for a mobile telephony endpoint to a different telephony endpoint associated with an IP address or a different telephone number without ever notifying the mobile telephony endpoint of the inbound call.

The mobile carrier network may provide connectivity for any wireless handsets (e.g., mobile telephony endpoint 220) capable of cellular transmission that are physically located within range of the mobile carrier network. The range of a mobile carrier network may depend, in part, on an amplification, power, and/or energy associated with the antennas comprising cellular basestations, wireless handsets and the like. As the wireless handset moves toward the outer range of the mobile carrier network, the strength of the cellular signals may degrade.

Similarly, an IP based data network may provide wireless connectivity to wireless handsets, such as mobile telephony endpoint 220, within range of an IP access point 245. For instance, IP access point 245 may provide wireless connectivity using any of the 802.11 WiFi standards, WiMAX standards, and/or any other type of IP based connectivity standard.

The collection of IP based data networks that all run on the IP packet based data transfer protocol may be characterized as packet switching networks. Packet switching may essentially chop up a data stream (e.g., text, voice, data) into segments and transfer them across an IP network to a destination where the packets are re-assembled into the original data stream for output. Voice over IP (VoIP) is a specialized subset of IP packet based communication directed to IP telephony. VoIP communication devices may utilize an IP access point (e.g., IP access point 245) to communicatively couple with the larger IP network. The IP access point may be wired, wireless (e.g., WiFi), or a combination wired/wireless access point. A VoIP telephony endpoint may communicate with an IP access point to gain access to the larger IP network and other communication devices.

In various embodiments, there is one aspect that each network (e.g., PSTN, VoIP, and mobile carrier) has in common that facilitates communication sessions among communication devices native to the various networks. In various such embodiments, the commonality may be that each communication device has a unique identifier associated with it, such as a telephone number (TN) or an IP address. The format of each type of identifier may be identical regardless of the network in use. For example, in North America, a TN is a ten-digit number. Communication devices in North America are associated with a 10-digit telephone number that subscribers ‘dial’ to reach other subscribers no matter the network the other subscriber uses. In various embodiments described herein, a TN may be used to determine an IP address. The IP address as used herein may comprise a socket address combination of an internet protocol (IP) address and a port number. Thus, users of communication devices may not need to worry about how to reach another user because communication devices can key off an associated telephone number. From the user's perspective, the networks may resolve any connection issues and enable calls to be connected so that a communication session may occur.

FIG. 2 illustrates another exemplary networked environment for communication between accessory device 235 and a communication device endpoint. In the illustrated embodiment the communication device endpoint may include an originating telephony endpoint 205. In various embodiments, the originating telephony endpoint 205 may place a call (e.g., establish a communication session) intended for a destination telephony endpoint—in this case mobile telephony endpoint 220. The call may traverse the originator's home telecom network 210 whatever that may be and be directed to a server, such as destination mobile carrier telecom server 215 associated with destination mobile telephony endpoint 220. The term mobile carrier telecom server 215 may be used broadly to encompass the hardware, systems, and interfaces necessary to authenticate and authorize a telephone call for a valid subscriber device such as destination mobile telephony endpoint 220. In some embodiments, one or more call forwarding policies may be utilized to allow accessory device 235 to participate in a communication session with originating telephony endpoint 205 without depending on a short range wireless communication link with mobile telephony endpoint 220. Embodiments are not limited in this context.

In various embodiments, if the mobile telephony endpoint 220 has engaged unconditional call forwarding for all inbound calls, the mobile carrier telecom server 215 may redirect the call to the telephone number associated with the unconditional call forwarding instruction without attempting to complete the call to the mobile telephony endpoint 220. In this scenario, the redirected call may be sent to a telephone number associated with private IP telecom server 225. In various embodiments, the telephone number may terminate within the private IP telecom server 225 in an IP network 207 like the Internet. In various such embodiments, the private IP telecom server 225 may forward the call to an accessory identifier, such as an IP address or telephone number associated with accessory device 235, based on the incoming call forward to a telephone number associated with the mobile telephony endpoint 220. As such, the private IP telecom server 225 may be considered a telephony endpoint with respect to the original call from the originating telephony endpoint 205. In some embodiments, the private IP telecom server 225 may maintain or have access to databases that associate the telephone number of the mobile telephony endpoint 220 with an accessory device 235 or accessory identifier associated with the accessory device 235, such as an IP address or telephone number. In various embodiments, the accessory device 235 may include one or more RF radios capable of 802.11 WiFi connectivity, cellular circuit-switched connectivity, and/or cellular IP data connectivity. In some embodiments, the private IP telecom server 225 may determine a registration status of the associated accessory device 235. If the associated accessory device 235 is currently registered as active or on-line within the private IP telecom server 225, a request to establish a communication link may be sent to the associated accessory device 235 using the appropriate protocol via one or more of an accessory device carrier telecom server 230 or an IP access point 245. This may be session initiation protocol (SIP) based communications for IP networks whether over 802.11 WiFi or cellular IP data or some other suitable protocol. The associated accessory device 235 may then accept the request to establish a communication link (e.g., voice channel) with the private IP telecom server 225. The private IP telecom server 225 in turn may join the associated accessory device 235 into the communication session already established with the originating telephony endpoint 205. Optionally or additionally, in various embodiments, the private IP telecom server 225 may attempt to establish a communication link with the mobile telephony endpoint 220 via a channel that does not involve a regular call to the mobile telephony endpoint's 220 telephone number, so as to be able to join the mobile telephony endpoint 220 to the call with the associated accessory device 235 and the originating telephony endpoint 205. For example, private IP telecom server 225 may connect with mobile telephone endpoint 220 via IP network 207 and IP access point 245. In various such embodiments, if the private IP telecom server 225 were to attempt to connect with the mobile telephony endpoint 220 via a regular call to the mobile telephony endpoint's 220 telephone number, that call may be forwarded the same as the original call and would never notify the mobile telephony endpoint 220 of the call. Thus, the accessory device 235 may be joined to the call regardless of its location or proximity to the mobile telephony endpoint 220.

Included herein is a set of flow charts and message diagrams representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

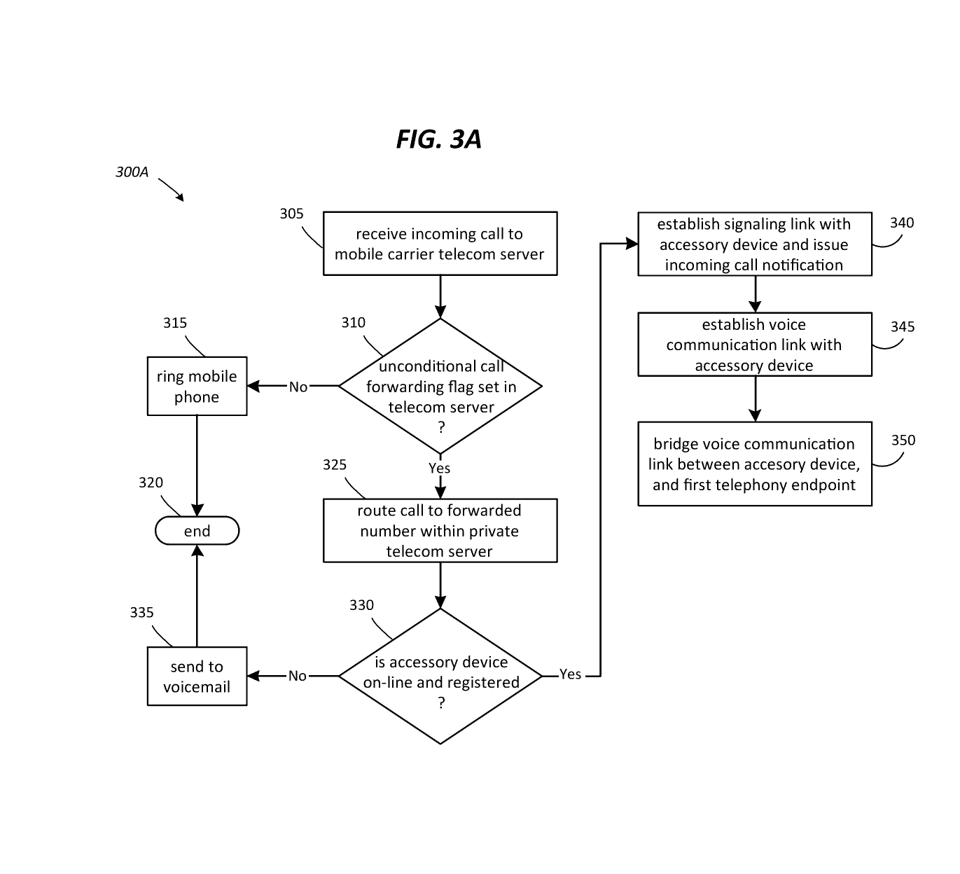

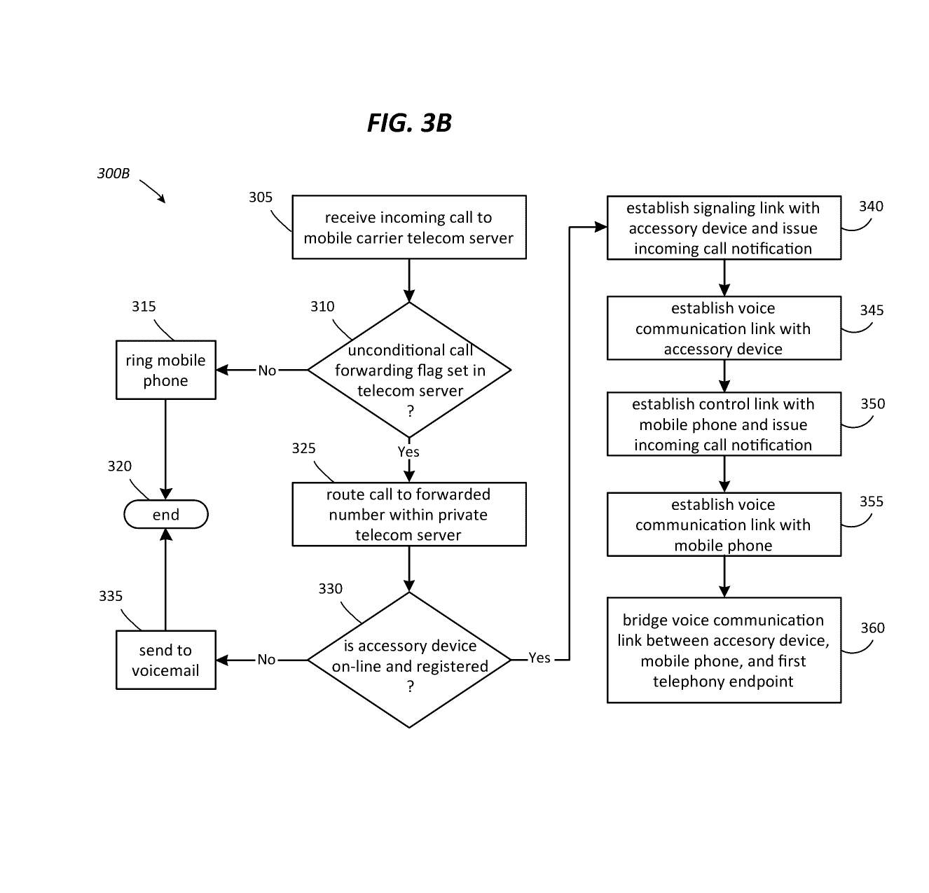

FIG. 3A illustrates an embodiment of a logic flow 300A for establishing a communication session between a communication device endpoint and accessory device 235. In some embodiments, the communication device endpoint may include an originating telephony endpoint 205. The logic flow 300A may be representative of some or all of the operations executed by one or more embodiments described herein. In the illustrated embodiment, steps are disclosed that may allow an accessory device 235 to join a communication session with the originating telephony endpoint 205 in lieu of the intended mobile telephony endpoint device 220 even if the accessory device 235 is not proximate to the mobile telephony endpoint device 220. Embodiments are not limited in this context.

In block 305, an inbound call may be received into a mobile carrier telecom server 215 intended for a telephone number associated with a mobile telephony endpoint 220 of a subscriber for that mobile telecom carrier. In block 310, the mobile carrier telecom server 215 may determine an unconditional call forwarding flag has been set. In various embodiments, the unconditional call forwarding flag may be set via mobile telephony endpoint 220. If unconditional call forwarding has not been set in block 310, the call may be routed normally to the mobile telephony endpoint 220 at block 315 and the process may terminate at block 320. If unconditional call forwarding has been set in block 310, the call may be redirected to a pre-determined telephone number associated with private telecom server 225 within an IP network 207 in block 325. In some embodiments, the telephone number associated with the mobile telephony endpoint 220 may be associated with an accessory device 235 or an accessory identifier associated with the accessory device 235, such as an IP address or telephone number, and the private telecom server 225 may maintain or have access to a database pairing that associates the telephone number of the mobile telephony endpoint 220 with the accessory device 235 or an accessory identifier associated with the accessory device 235, such as an IP address or telephone number. In various embodiments the telephone number of mobile telephony endpoint 220 may be determined by the private telecom server 225 based on various party identifying information included in the signaling when the call is redirected to the pre-determined telephone number. For instance, when a call is redirected to the pre-determined number associated with private telecom server 225, the telephone number of the redirected call may identify the telephone number associated with the mobile telephony endpoint 220. In other embodiments, the redirection information contained in the signaling may identify the original called telephone number associated with the mobile telephony endpoint 220.

In block 330, the private IP telecom server 225 may determine if the accessory device 235 associated with the mobile telephony endpoint 220 is on-line and registered. If the accessory device 235 is unavailable (e.g., not registered and/or not online), the inbound telephone call may be sent to a voice mailbox in block 335 and the process may terminate at block 320. If the accessory device 235 associated with the accessory identifier is on-line and/or registered, the private IP telecom server 225 may establish a signaling communication link and send an inbound call notification to the accessory device 235 in block 340. In block 345, the private IP telecom server 225 may establish a voice communication link with the accessory device 235. In block 350, the private IP telecom server may bridge or join the accessory device 235 communication link with the originating telephony endpoint 205 to create a communication session that includes the accessory device 235 regardless of its proximity to the mobile telephony endpoint 225.

FIG. 3B illustrates an embodiment of a logic flow 300B for establishing a communication session between two communication device endpoints and an accessory device 235. In some embodiments, the two communication device endpoints may include originating telephony endpoint 205 and mobile telephony endpoint 220. The logic flow 300B may be representative of some or all of the operations executed by one or more embodiments described herein. In the illustrated embodiment, steps are disclosed that may allow an accessory device 235 to join a communication session even if the accessory device 235 is not proximate to the mobile telephony endpoint device 220. Steps 305-345 may be the same or similar to those described above for logic flow 300A of FIG. 3A. In logic flow 300B, three additional or different steps may be performed. In block 352, the private IP telecom server 225 may establish a signaling communication link and send an inbound call notification to the mobile phone telephony endpoint 220. In block 355, the private IP telecom server 225 may attempt to establish a media communication link back to the mobile telephony endpoint 220 to include it on the call as well. If successful in establishing a communication link, the private IP telecom server may bridge or join the mobile telephony endpoint 220 communication link with the originating telephony endpoint 205 as well. Embodiments are not limited in this context.

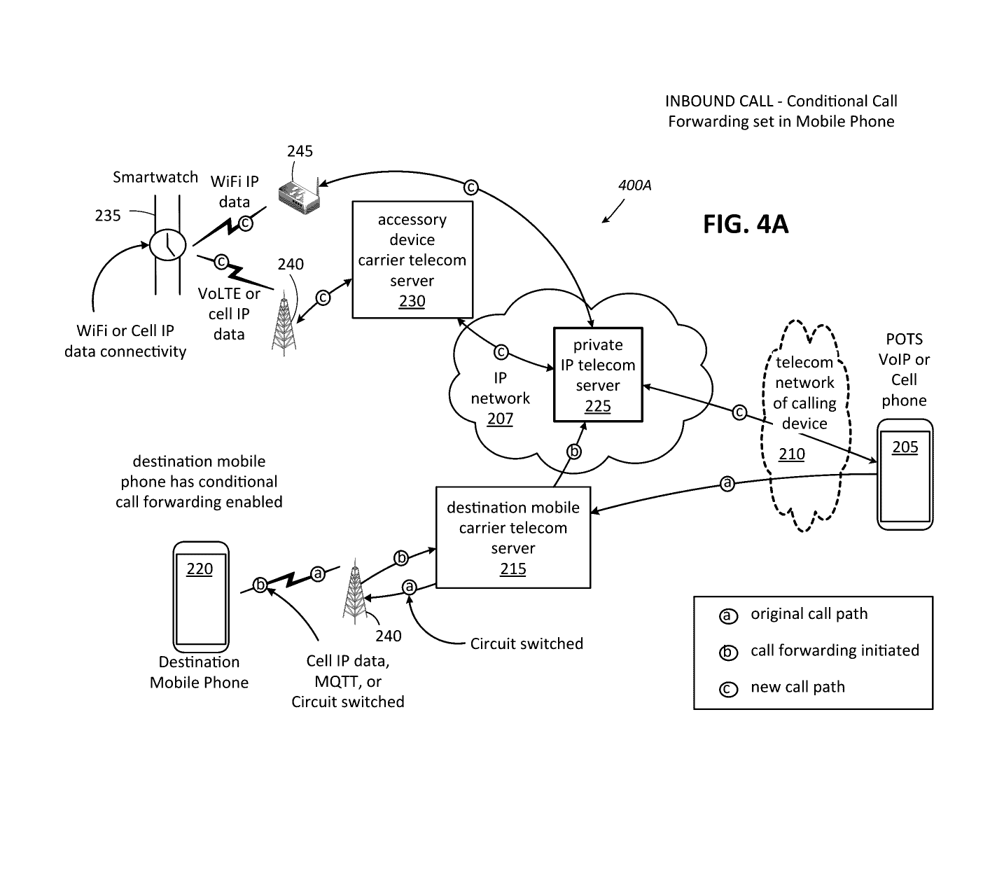

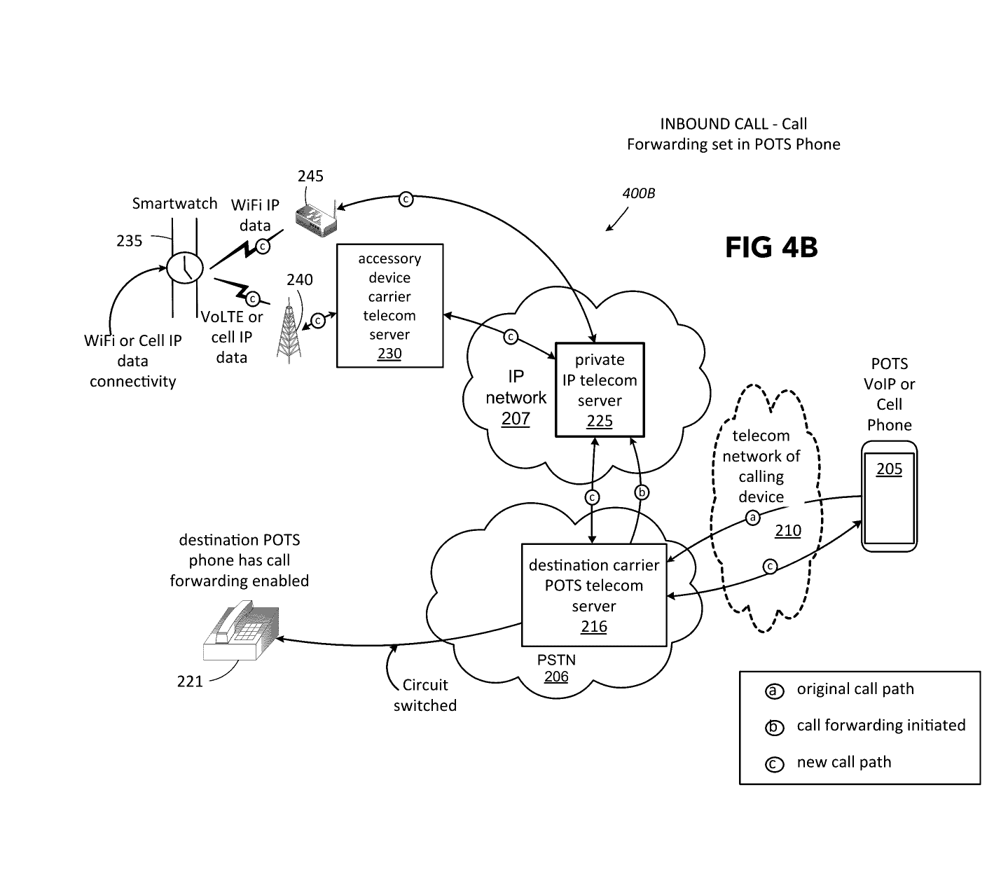

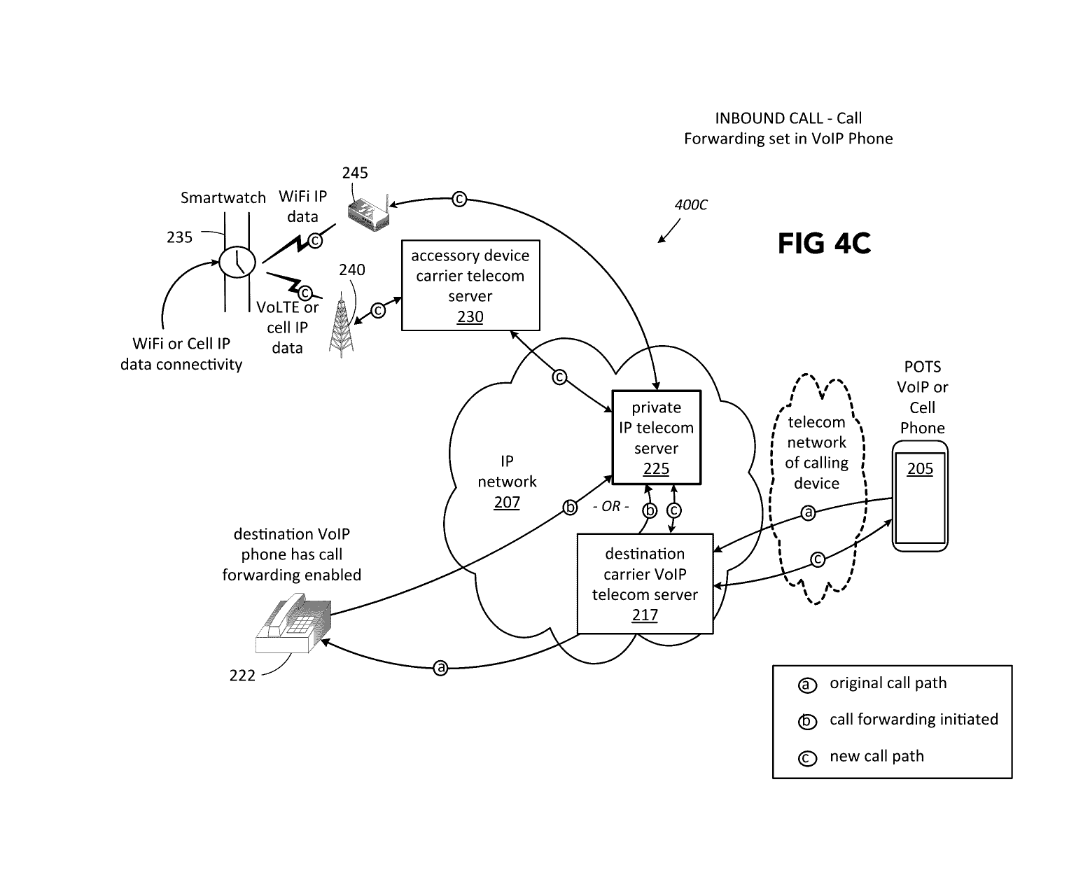

FIG. 4A illustrates another exemplary networked environment for communication between an accessory device 235 and a communication device endpoint. In the illustrated embodiment, the communication device endpoint may include originating telephony endpoint 205. The description for FIG. 4A may be the same or similar to that of FIG. 2. A notable exception may be that conditional call forward is used as opposed to unconditional forwarding. Conditional call forwarding may be performed at either the mobile carrier telecom server 215 or at the mobile telephony endpoint 220. Various embodiments of conditional call forward can include call forward no answer, call forward busy, call forward unreachable. For example, a call may be forwarded to accessory device 235 only after no answer is made at the mobile telephony endpoint 220. This may provide a user with the ability to shift a call to accessory device 235. In another example the mobile telephony endpoint 220 may be unreachable due to lack of battery, but the user may be able to receive the call on accessory device 235. Embodiments are not limited in this context.

FIG. 4B illustrates yet another exemplary networked environment for communication between an accessory device 235 and a communication device endpoint. In the illustrated embodiment the communication device endpoint may include originating telephony endpoint 205. The description of FIG. 4B may be the same or similar to that of FIG. 2 with POTS telecom server 216 in PSTN 206 replacing mobile carrier telecom server 215 and POTS telephony endpoint 221 replacing mobile telephony endpoint 220. A notable exception may be that rather than unconditional call forwarding, this embodiment envisions a conditional call forwarding mechanism that may be performed by the POTS telecom server 216. For example, a call may be forwarded to accessory device 235 only after no answer is made at the POTS telephony endpoint 221. Thus, it may be possible to shift a call to an accessory device that may be linked with more than just a mobile telephony endpoint 220. Embodiments are not limited in this context.

FIG. 4C illustrates still another exemplary networked environment for communication between an accessory device 235 and a communication device endpoint. In the illustrated embodiment, the communication device endpoint may include first telephony endpoint 205. The description of FIG. 4C may be the same or similar to that of FIG. 2 with VoIP telecom server 217 in IP network 207 replacing mobile carrier telecom server 215 and VoIP telephony endpoint 222 replacing mobile telephony endpoint 220. A notable exception may be that the call forwarding may be performed at the VoIP telephony endpoint 222 rather than at the carrier VoIP telecom server 217. Rather than unconditional call forwarding which may be performed at the VoIP telecom server 217, this embodiment envisions a call forwarding no answer mechanism that may be performed on a VoIP telephony endpoint 222. For example, a call may be forwarded to accessory device 235 only after no answer is made at the VoIP telephony endpoint 221. Thus, it may be possible to shift a call to an accessory device may be linked with more than just a mobile telephony endpoint 220. Embodiments are not limited in this context.

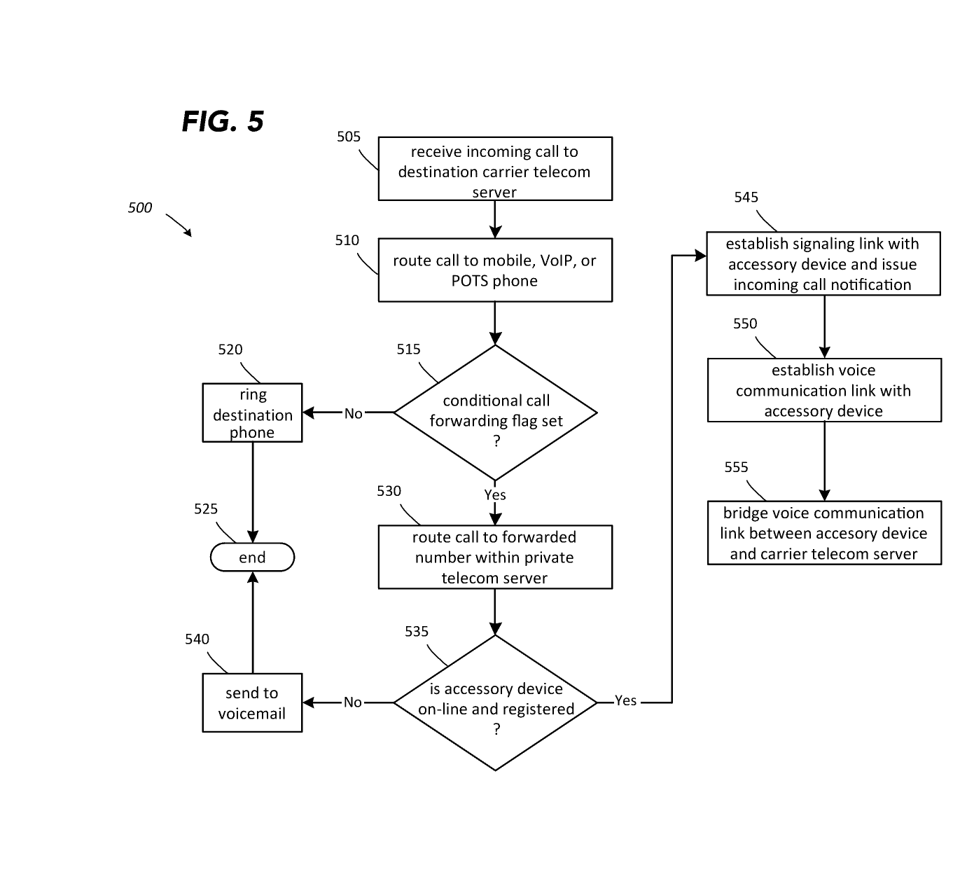

FIG. 5 illustrates yet another embodiment of a logic flow 500 for establishing a communication session between a communication device endpoint and an accessory device 235. In some embodiments, the communication device endpoint may include originating telephony endpoint 205. The logic flow 500 may be representative of some or all of the operations executed by one or more embodiments described herein. In this embodiment, steps are disclosed that may allow accessory device 235 to join a communication session even if the accessory device 235 may not be proximate to the POTS or VoIP telephony endpoint 221, 222. The steps of logic flow 500 may be the same or similar to those described above for FIG. 3A. In logic flow 500, however, the inbound call may be received by POTS telecom server 216 associated with PSTN 206 or VoIP telecom server 217 associated with IP network 207 rather than mobile carrier telecom server 215. Also, the inbound call may be routed to POTS telephony endpoint 221 or VoIP telephony endpoint 222 before being redirected based on a call forwarding policy. Embodiments are not limited in this context.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Although the flowcharts of FIGS. 3A, 3B, and 5 each show a specific order of execution, it is understood that the order of execution may differ from that which is depicted. Also, steps shown in succession in the flowcharts may be executed concurrently or with partial concurrence. Further, in some embodiments, one or more of the steps shown in the flowcharts may be skipped or omitted. In addition, any number of counters, state variables, warning semaphores, or messages might be added to the logical flows described herein, for purposes of enhanced utility, accounting, performance measurement, or providing troubleshooting aids, etc. It is understood that all such variations are within the scope of the present disclosure. For instance, any features or functionality described with respect to mobile telephony endpoint 220, POTS telephony endpoint 221, and VoIP telephony endpoint 222 may readily be utilized or realized with respect to any other type of telephony endpoint without departing from the scope of the present disclosure.

Where any component discussed herein is implemented in the form of software, any one of a number of programming languages may be employed such as, for example, C, C++, C#, Objective C, Java, JavaScript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

A memory may include both volatile and nonvolatile memory and data storage components. Volatile components are those that do not retain data values upon loss of power. Nonvolatile components are those that retain data upon a loss of power. Thus, a memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may comprise additional systems designed to coordinate this communication, including, for example, performing load balancing. A processor may be of electrical or of some other available construction.

Systems and components described herein may be embodied in software or code executed by general purpose hardware, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Also, any logic, functionality or application described herein that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

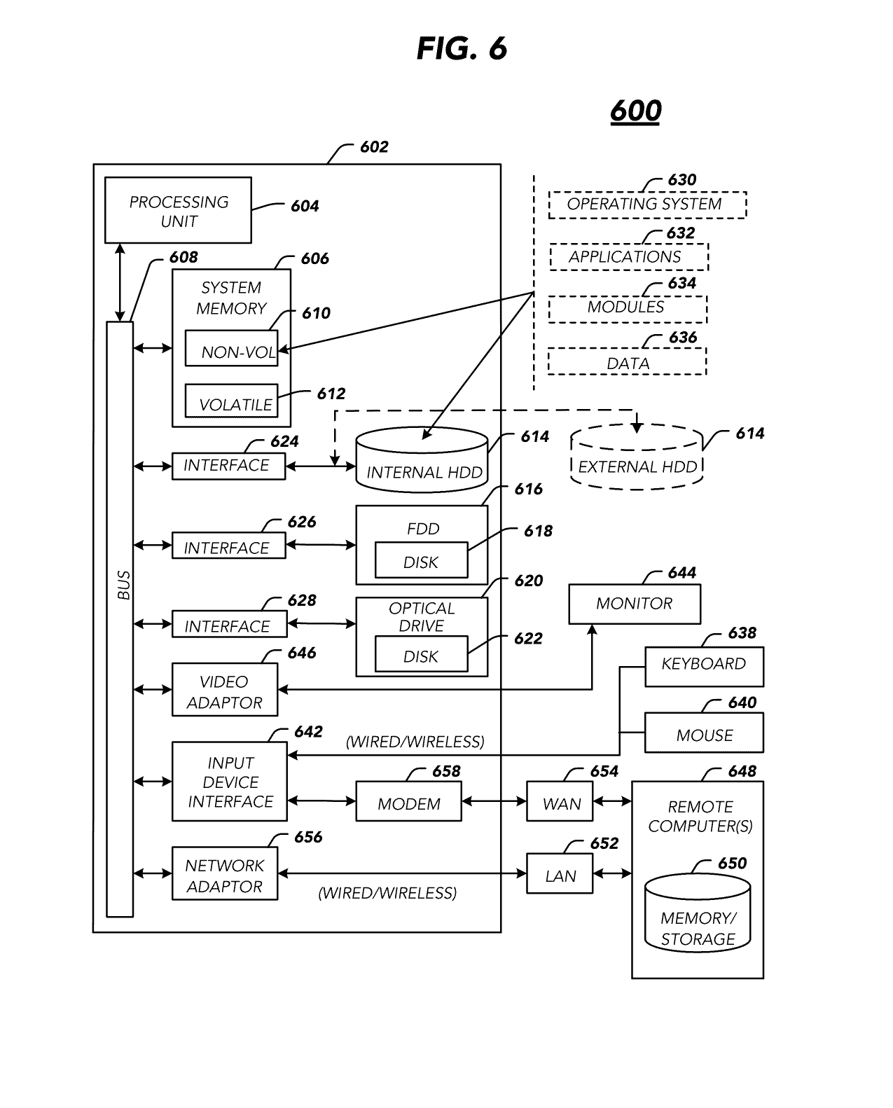

FIG. 6 illustrates an embodiment of an exemplary computing architecture 600 suitable for implementing various embodiments as previously described. In one embodiment, the computing architecture 600 may include or be implemented as part of one or more systems and devices discussed herein such as private IP telecom server 225.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical, solid state and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or multiple of Universal Serial Bus (USB), Thunderbolt, eSATA, and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications, components, and/or features described herein.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
memory;
logic, at least a portion of which is implemented in circuitry coupled to the memory, the logic to:
in a private telecom server;
receive a forwarded inbound call, the forwarded inbound call redirected from a first telecom server, the forwarded inbound call placed from an originating telephony endpoint and directed to a telephone number associated with a destination telephony endpoint;
identify an accessory device associated with the telephone number of the destination telephony endpoint;
determine a registration status of the accessory device; and
route the forwarded call to the accessory device via an accessory device identifier when the registration status of the accessory device is on-line.

2. The apparatus of claim 1, the registration status of the accessory device indicative of whether the accessory device is on-line.

3. The apparatus of claim 2, the logic to:
establish a signaling communication link with the accessory device and issue an incoming call notification to the accessory device based on the registration status.

4. The apparatus of claim 3, the logic to:
establish a media communication link with the accessory device.

5. The apparatus of claim 4, the logic to:
bridge the communication link between the accessory device and the originating telephony endpoint.

6. The apparatus of claim 4, the logic to:
establish a signaling communication link with the destination telephony endpoint and issue an incoming call notification to the destination telephony endpoint.

7. The apparatus of claim 6, the logic to:
establish a media communication link with the destination telephony endpoint.

8. The apparatus of claim 7, the logic to:
bridge a communication link between the accessory device, the originating telephony endpoint, and the destination telephony endpoint.

9. The apparatus of claim 8, the logic to:
route the forwarded call to a voicemail associated with the destination telephony endpoint based on the registration status of the accessory device.

10. The apparatus of claim 1, the accessory device identifier comprising a socket address combination of an internet protocol (IP) address and a port number.

11. The apparatus of claim 1, the accessory device identifier comprising a telephone number.

12. The apparatus of claim 1, the accessory device including one or more of a smartwatch, a fitness tracking dongle, jewelry, smartglasses, a boat, an automobile, and a bike.

13. The apparatus of claim 4, the accessory device including a radio to utilize one or more networks or protocols associated with or capable of facilitating voice telecommunications.

14. A computer-implemented method, comprising:
receiving a forwarded inbound call, the forwarded inbound call redirected from a first telecom server, the forwarded inbound call placed from an originating telephony endpoint and directed to a telephone number associated with a destination telephony endpoint;
identifying an accessory device associated with the telephone number of the destination telephony endpoint;
determining a registration status of the accessory device; and
routing the forwarded call to the accessory device via an accessory device identifier when the registration status of the accessory device is on-line.

15. The computer-implemented method of claim 14, the registration status of the accessory device indicative of whether the accessory device is on-line.

16. The computer-implemented method of claim 15, comprising:
establishing a signaling communication link with the accessory device; and
issuing an incoming call notification to the accessory device based on the registration status.

17. The computer-implemented method of claim 16, comprising establishing a media communication link with the accessory device.

18. The computer-implemented method of claim 17, comprising bridging a communication link between the accessory device and the originating telephony endpoint.

19. The computer-implemented method of claim 14, the registration status of the accessory device indicating the accessory device is unavailable.

20. The computer-implemented method of claim 19, comprising routing the forwarded call to a voicemail associated with the destination telephony endpoint based on the registration status of the accessory device.

21. The computer-implemented method of claim 19, comprising routing the forwarded call back to the destination telephony endpoint based on the registration status of the accessory device.

22. The computer-implemented method of claim 14, the accessory identifier comprising a socket address combination of an internet protocol (IP) address and a port number.

23. The computer-implemented method of claim 14, the accessory identifier comprising a telephone number.

24. The computer-implemented method of claim 14, the accessory device comprising one or more of a smartwatch, a fitness tracking dongle, jewelry, smartglasses, a boat, an automobile, and a bike.
